(19) United States
(12) Patent Application Publication
(10) Pub. No.: US 2009/0128093 A1
(43) Pub. Date: May 21, 2009

(54) Accumulator And Combination Of Accumulator With Device

(76) Inventors: Radu Barza, Heubach (DE); Alfred Schreiber, Kirchheim (DE)

Correspondence Address: ST. ONGE STEWARD JOHNSTON & REENS, LLC, 986 BEDFORD STREET, STAMFORD, CT, 06905-5619, US

(21) Appl. No.: 12/249,190

(22) Filed: Oct. 10, 2008

(30) Foreign Application Priority Data
Oct. 16, 2007 (DE) 10 2007 051 051.0

(51) Int. Cl. H01M 10/48; H02J 7/00

(52) U.S. Cl. 320/132; 429/90

(57) ABSTRACT

The invention discloses an accumulator/device combination and an accumulator. In the case of the combination, the unit is connected to the accumulator via at least one current supply line. A device operating switch is arranged in the device. A monitoring unit is arranged in the accumulator. The monitoring unit comprises electronic circuit for detecting an alarm condition in the accumulator. The electronic circuit are interactively connected with the operating switch.

### BACKGROUND OF THE INVENTION

The present invention relates to an accumulator/device combination.

The invention further relates to an accumulator.

In line with the general trend towards portable wireless electric and electronic devices of all kinds, there exists an increasing need for accumulators to secure the power supply of such devices. On the other hand, the increasing use of accumulators leads to a need for charging devices that enable such accumulators to be recharged if and when necessary.

The term “devices” is used in the present invention to describe in the first line consumers of all kinds that require an accumulator as power supply, especially electric tools and related devices. On the other hand, it is also understood to describe charging devices.

When an accumulator is connected to a consumer it draws current from the consumer, and it must then be guaranteed that the accumulator will not be damaged in that process, especially by excessive current drain or by being fully discharged. On the other hand, when an accumulator is connected to a charging device and is recharged with current drawn from the charging device it must be guaranteed that the accumulator will not be damaged by an excessive current flow or due to overcharging of the accumulator. Depending on the particular type of accumulator, the accumulator may be damaged or even destroyed under such circumstances.

In mobile applications of the before-mentioned kind, there are in use today accumulators of different kinds, known as “battery packs”, for example nickel-cadmium batteries (NiCd), nickel-metal hydride batteries (NiMH) and lithium-ion batteries. In the latter case, batteries using different metals (Mn, Ni, Co, Ti) in diverse combinations have been known. While LiCoO₂ batteries are in use for electronic devices, such as portable computers, LiMn₂O₄, LiNiO₂, LiTi₅O₁₂, LiNi₁₋ₓCOₓO₂ and the like are used for applications in electric tools, which is the field of particular interest for purposes of the present invention. Those accumulators have a cell mains voltage of between 3.6 and 3.7 Volts. More recently, lithium ion batteries of the lithium iron phosphate type have become known that have a cell mains voltage of 3.3 Volts.

With respect to the accumulator type, the invention is not limited to the examples listed above.

### SUMMARY OF THE INVENTION

It is a first object of the invention to disclose an accumulator/device combination that prevents the drawbacks discussed above.

It is a second object of the invention to disclose an accumulator/device combination that ensures a correct charging of the accumulator if connected to a charging device.

It is a third object of the invention to disclose an accumulator/device combination that avoids an excessive current of the accumulator.

It is a further object of the invention to disclose an accumulator and an accumulator/device combination that avoid damage to the accumulator by excessive charging or de-charging.

It is a further object of the invention to disclose an accumulator that signals to a charging device its charging state and/or information about the type of the accumulator.

It is a further object of the invention to avoid damage to or even destruction of the accumulator by improper current drain or current injection, and this safely and with the least possible technical input.

The invention achieves these and other objects by an accumulator/device combination of the kind mentioned wherein the device is connected to the accumulator via at least one current supply line, with a device operating switch arranged in the device and a monitoring unit arranged in the accumulator, the monitoring unit comprising means for detecting an alarm condition and the means being interactively connected with the operating switch.

The object is further achieved according to the invention by an accumulator comprising at least one current supply connection for connecting the accumulator to a device, with a monitoring unit arranged in the accumulator, the monitoring unit comprising means for detecting an alarm condition arranged in the accumulator and the means being connected to a signal connection of the accumulator.

The object of the invention is perfectly achieved in this way.

This is so because the invention makes use of the fact that devices of the kind of interest in the present case, for example an electric tool as consumer or a charging device, are anyway provided with an operating switch so that, accordingly, the accumulator can be protected in an extremely simple way by interrupting the power supply to the consumer or the current supply from the charging device by actuation or disconnection of the operating switch.

In this respect, an arrangement is preferred where the at least one current supply line is de-energized by operation of the operating switch.

Alternatively, the means may disconnect the device in full, for example by interruption of the at least one current supply line.

It is further preferred if the monitoring unit is an electronic monitoring system.

In certain especially preferred embodiments of the invention the electronic monitoring system monitors a state variable characteristic of the accumulator and the means come to interact with the operating switch when a predefined threshold value of the state variable is exceeded.

In certain variants of those embodiments the state variable may be the voltage, for example the charging voltage, the current, for example the charging current, the internal resistance or the temperature of the accumulator, or else the first time derivative of the before-mentioned values. A monitoring of the first time derivative provides very reliable results

In certain embodiments of the invention, at least two state variables are monitored at the same time.

That feature provides the advantage that critical states can be detected even more precisely.

In certain further embodiments of the invention, the alarm condition is indicated by a voltage signal at a signal connection of the accumulator, especially in that the signal connection is supplied with a zero signal when no alarm condition exists and is supplied with a voltage when an alarm signal is encountered.

That feature provides the advantage that an extremely simple arrangement is achieved which will remain functional even in case the remaining device or its control should become defective.

Further advantages of the invention will become apparent from the specification and the attached drawing.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Certain embodiments of the invention are shown in the drawing and will be discussed in more detail in the specification that follows. In the drawing

FIG. 1 shows a schematic circuit diagram of a first embodiment of an accumulator/device combination according to the invention with the accumulator connected to a charging device;

FIG. 2 shows a second embodiment of the invention similar to the configuration illustrated in FIG. 1;

FIG. 3 shows a third embodiment of the invention similar to the configuration illustrated in FIG. 1;

FIG. 4 shows a forth embodiment of the invention similar to the configuration illustrated in FIG. 1;

FIG. 5 shows a circuit diagram similar to that illustrated in FIG. 1, but for an accumulator/device combination where the accumulator is connected to an electric consumer.

### DETAILED DESCRIPTION OF THE PREFERRED EMBODIMENTS

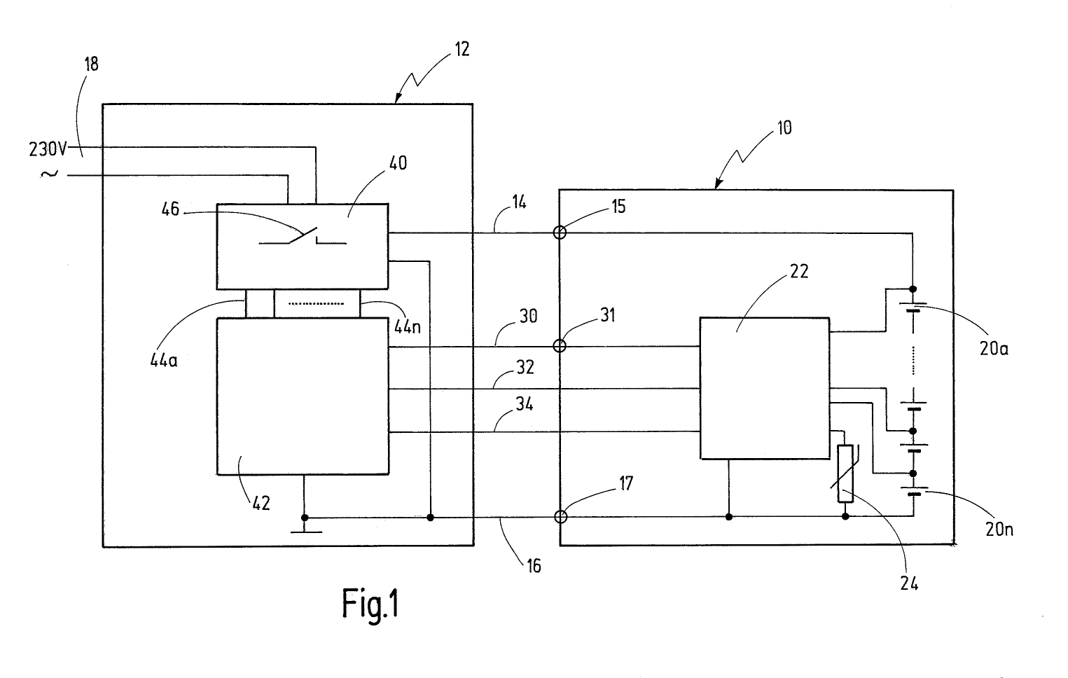

In FIG. 1, an accumulator, colloquially also known as “battery pack”, is indicated generally by reference numeral 10. The accumulator is a lithium ion accumulator.

The accumulator 10 is connected to a device, i.e. a charging device 12 in the example of FIG. 1. The connection between the charging device 12 and the accumulator 10 is established by a positive line 14 and a grounding line 16, the corresponding current supply connections of the accumulator 10 being indicated by 15 and 17. The charging device 12 is connected to a mains, for example a 230 V AC mains, via a supply line 18.

The accumulator 10 comprises n cells 20a-20n in series connection. The cells 20a-20n are connected to an electronic monitoring system 22. Arranged close to the cells 22a-22n is a temperature sensor 24, for example an NTC resistor, which is likewise connected to the electronic monitoring system 22.

The electronic monitoring system 22 comprises means capable of generating signals that correspond to the current I, for example the charging current, the voltage U, especially the charging voltage, the inner resistance Rᵢ of the cells 22a-22n, the temperature I of the cells 22a-22n and, if necessary, to other parameters characteristic of the charging state of the accumulator. Especially, the electronic monitoring system 22 is capable of detecting the variation in time, i.e. the first time derivative of those parameters, and of generating corresponding signals, for example dU/dt, dI/dt, dT/dt and dRᵢ/dt. The electronic monitoring system may also monitor two or more state variables at the same time.

Further, the electronic monitoring system may generate from those signals secondary signals indicating, for example, an alarm condition of the cells 22a-22n, for example a state of imminent overcharging, of imminent complete undercharging, overvoltage, overload current, overheating, etc. The signals so determined/or processed are sent to the charging device 12 via signal lines 30, 32 and 34, especially via a signal connection 31 of the accumulator 10 which is connected to the signal line 30.

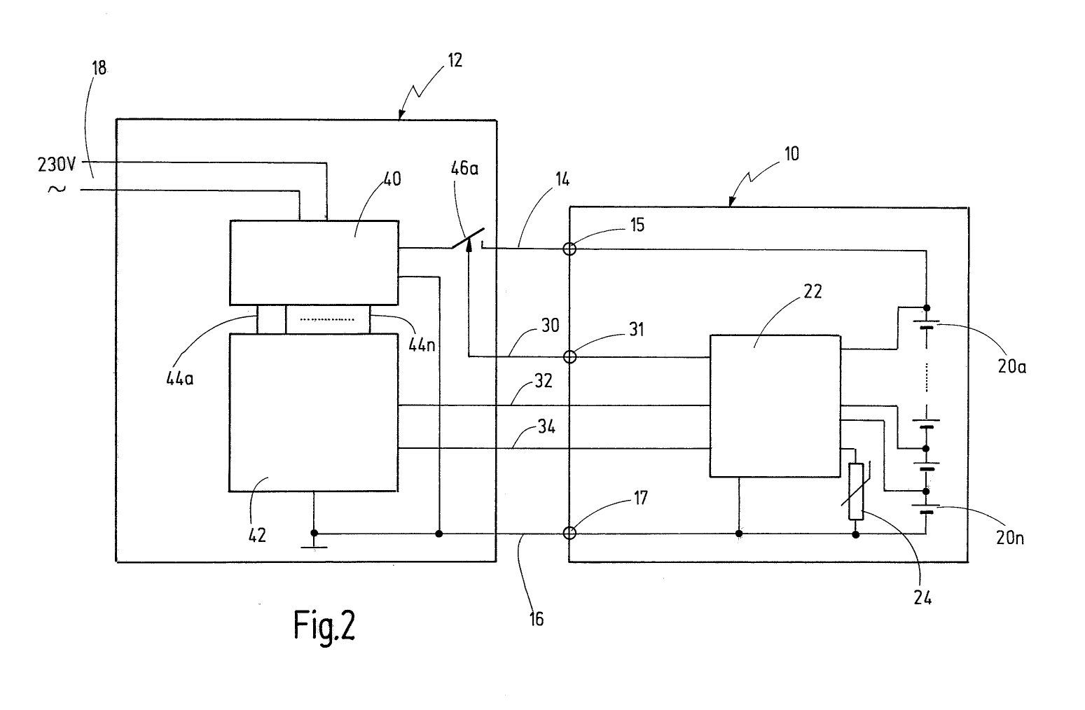

The charging device 12 comprises a switching-mode power supply 40 and an electronic control 42 that are connected one to the other via a plurality of control lines 44a-44n. In the case of the embodiment illustrated in FIG. 1 the switching-mode power supply 40 comprises a switch, which is indicated by 46 and which acts as operating switch, by which the charging device 12 can be completely disconnected or at least one of the current supply lines 14, 16 can be de-energized, especially interrupted, by electronic means. The switch 46 may also be arranged at a different point of the charging device 12, as will be explained hereafter with reference to FIGS. 2 to 4.

The electronic control system 42 receives the signals discussed above via the signal lines 30, 32 and 34 and adjusts the charging current I via the switching-mode power supply 40 in the manner envisaged by the method according to the invention.

Once a signal indicating an alarm condition of the cells 22a-22n is generated by the electronic monitoring system 22 in the manner described above that signal causes the charging device 12 to be switched off in full. For example, if no alarm condition is detected, a signal “0” will appear at the signal connection and, thus, on the signal line 30, while a finite voltage signal “1” of, for example, +18 V will be encountered when an alarm condition is detected indicating, for example, an imminent overcharging or an imminent fully discharged condition. It goes without saying that the signal forms “0” or “+18V” have been used here by way of example only and that other analogue or, for example, digital signal forms may be used as well.

In the case of the first variant of the embodiment of FIG. 1, illustrated in FIG. 2, the switch indicated in this case by 46a is arranged in the positive line 14. The switch 46a may be configured as a relay or as a semiconductor switch, for example.

The accumulator 10 and/or the electronic monitoring system 22 actuate the switch 46a directly with the signal line 30 acting as “emergency shutdown”. The switch 46a is located on the secondary side of the charging device 12 in this case.

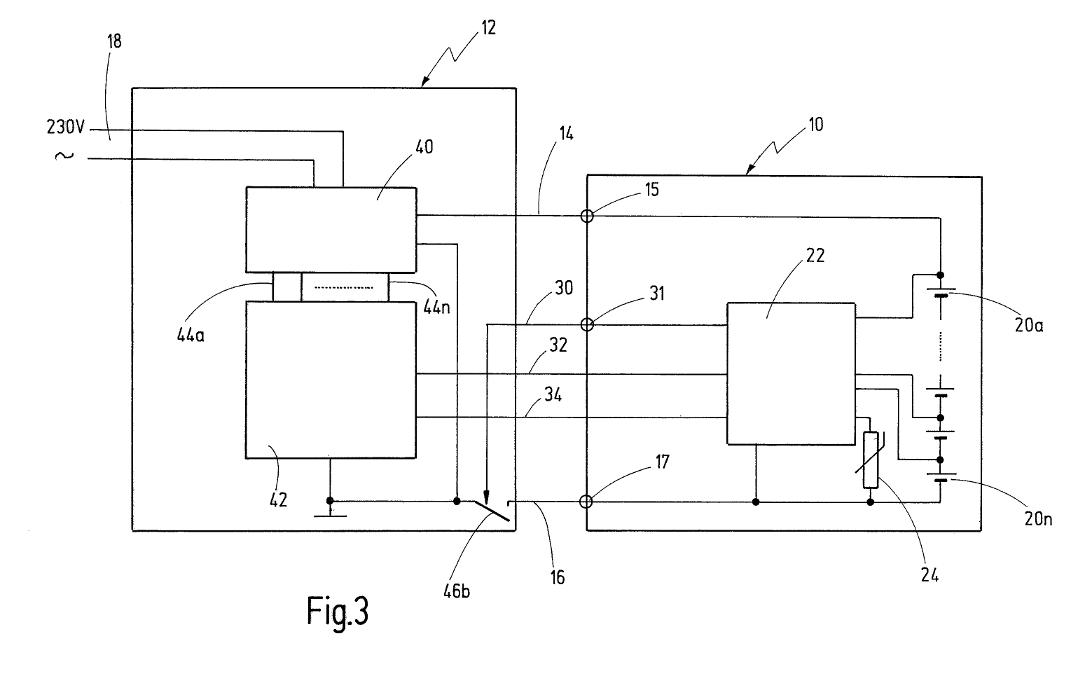

Correspondingly, FIG. 3 shows a second variant where the switch, indicated by 46b in this case, is arranged in the grounding line 16. For the rest, the function of this arrangement corresponds to that illustrated in FIG. 2.

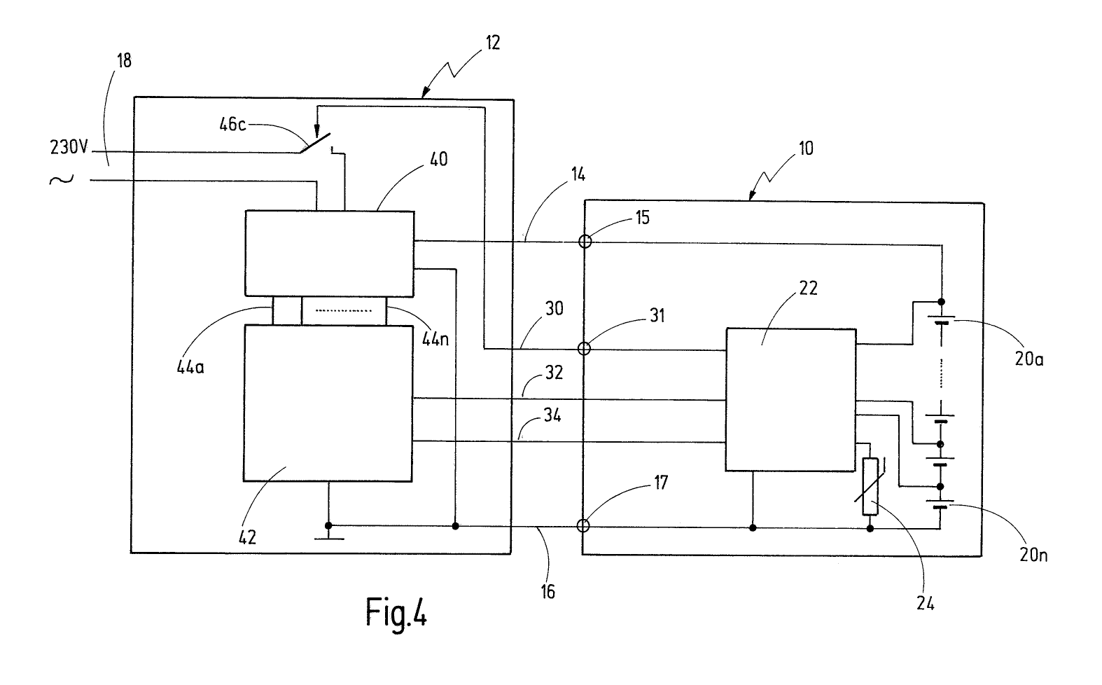

Finally, FIG. 4 shows a third variant where the switch, indicated by 46c in this case, is arranged in the supply line 18. Here again, the signal line 30 acts as “emergency shutdown” function. However, the switch 46c is now arranged on the primary side of the charging device 12. Combinations of the embodiments illustrated in FIGS. 2 to 4 using two or more switches are likewise imaginable.

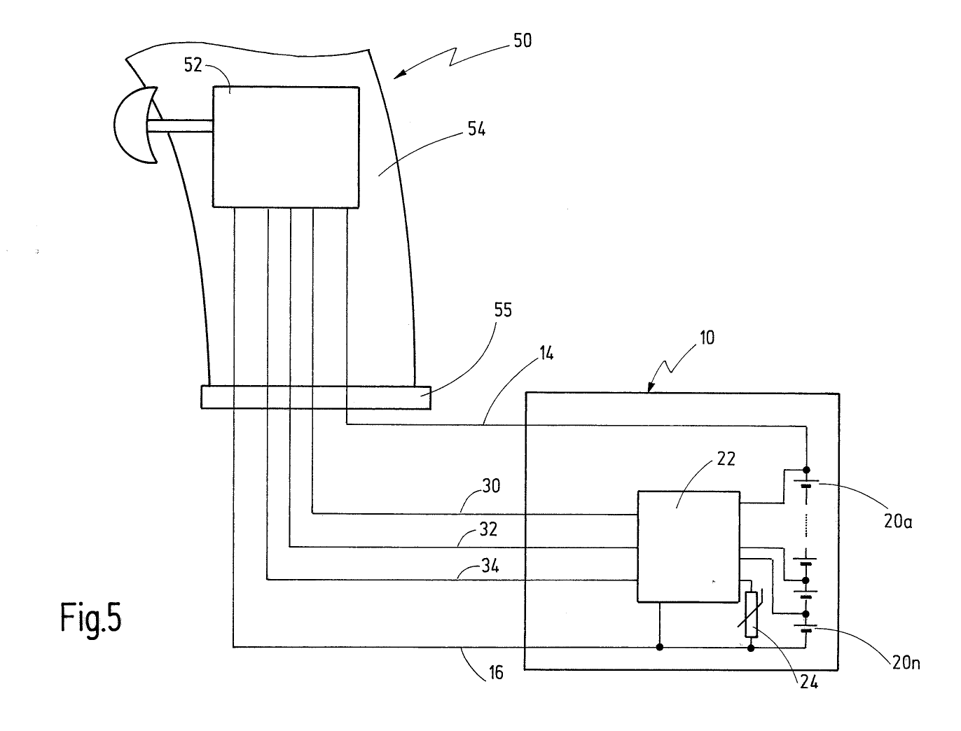

FIG. 5 shows that the described alarm interrupt function can be used also with the accumulator 10 connected to a consumer, for example a manually operated electric tool 50 as indicated in FIG. 5, or to any other electric or electronic device. The electric tool 50, for example a drilling machine, a cut-off grinder, a screwing machine, or the like, comprises an operating switch 52 in a handle 54. A connection indicated by 55 connects the electric tool 50 with the accumulator 10. The accumulator 10 has been illustrated in FIG. 5 beside the electric tool 50 for the sake of simplicity only. In practice, the accumulator is of course arranged in the electric tool 50.

In operation of the electric tool 50, when there is a risk that the accumulator 10 may get fully discharged or overheated, then the alarm signal described above causes the operating switch 52 to be actuated and, thus, the electric tool 50 to be cut off via the signal line 30. This may be effected by mechanically triggering the operating switch 52 or by electrically decoupling the operating switch 52 via a relay, a semiconductor switch or the like.

What is claimed is:

1. A combination of an accumulator and a charging or consumer device, the combination comprising:
at least one current supply line for connecting the accumulator to the device;
a device operating switch arranged in the device; and
a monitoring unit arranged in the accumulator;
wherein said monitoring unit comprises an electronic circuit for detecting an alarm condition in the accumulator, said electronic circuit being interactively connected with said operating switch.

2. The combination of claim 1, wherein said electronic circuit is configured for de-energizing the at least one current supply line by actuating said operating switch.

3. The combination of claim 1, wherein said electronic circuit comprises as a switch for disconnecting said device from said accumulator.

4. The combination of claim 3, wherein said electronic circuit comprises a switch for interrupting said at least one current supply line from said accumulator.

5. The combination of claim 1, wherein said monitoring unit is configured for monitoring a state variable characteristic of the accumulator, and wherein said electronic circuit is configured for interacting with said operating switch when a predefined threshold value of the state variable is exceeded.

6. The combination of claim 5, wherein said monitoring unit is configured for monitoring a state variable that is selected from the group consisting of a voltage of the accumulator, a current of the accumulator, a temperature of the accumulator, and an inner resistance of the accumulator.

7. The combination of claim 1, wherein said monitoring unit is configured for monitoring a first time derivative of a state variable characteristic of the accumulator.

8. The combination of claim 1, wherein said monitoring unit is configured for monitoring a first time derivative of state variable characteristic of the accumulator, wherein said state variable is selected from the group consisting of a voltage of the accumulator, a current of the accumulator, an inner resistance of the accumulator, and a temperature of the accumulator.

9. The combination of claim 1, wherein said monitoring unit is configured for monitoring at least two state variables at the same time.

10. The combination of claim 1, wherein said accumulator comprises a signal terminal for indicating an alarm condition by a voltage signal.

11. The combination of claim 10, wherein a zero signal appears at the signal terminal when no alarm condition exists and a voltage signal is encountered in the presence of an alarm condition.

12. An accumulator comprising:
at least one current supply terminal for connecting the accumulator to an external device;
a monitoring unit arranged in the accumulator, said monitoring unit being configured for monitoring a state variable characteristic of the charging state of the accumulator;
a signal terminal; and
an electronic circuit arranged within the accumulator for detecting an alarm condition detected by said monitoring unit;
wherein said electronic circuit is connected to said signal terminal.

13. The accumulator of claim 12, wherein said monitoring unit is configured for monitoring a state variable characteristic of the charging state of the accumulator, and wherein said electronic circuit is configured for supplying a voltage signal to the signal terminal when a predefined threshold value of said state variable is exceeded.

14. The accumulator of claim 12, wherein a zero signal appears at the signal connection when no alarm condition exists and a voltage signal is encountered in the presence of an alarm condition.

15. The accumulator of claim 12, wherein said electronic circuit is configured for supplying a voltage signal to the signal terminal when a predefined threshold value of said state variable is exceeded, the state variable being selected from the group consisting of a voltage, a current, an inner resistance, a temperature of the accumulator.

16. The accumulator of claim 12, wherein said electronic circuit is configured for supplying a voltage signal to the signal terminal when a predefined threshold value of a first time derivative of said state variable is exceeded.

17. The accumulator of claim 12, wherein said electronic circuit is configured for supplying a voltage signal to the signal terminal when a predefined threshold value of a first time derivative of a state variable is exceeded, wherein said state variable is selected from the group consisting of a voltage of the accumulator, a current of the accumulator, an inner resistance of the accumulator and a temperature of the accumulator.

18. An accumulator comprising:
at least one current supply terminal for connecting the accumulator to an external device;
a monitoring unit arranged in the accumulator, said monitoring unit being configured for monitoring a state variable characteristic of the charging state of the accumulator;
a signal terminal; and
an electronic circuit arranged within the accumulator for detecting an alarm condition detected by said monitoring unit;
wherein said electronic circuit is connected to said signal terminal;
wherein said monitoring unit is configured for monitoring a state variable characteristic of the charging state of the accumulator; and
wherein said electronic circuit is configured for supplying a voltage signal to the signal terminal when a predefined threshold value of said state variable is exceeded.

19. The accumulator of claim 18, wherein said electronic circuit is configured for supplying a voltage signal to the signal terminal when a predefined threshold value of said state variable is exceeded, the state variable being selected from the group consisting of a voltage, a current, an inner resistance, a temperature of the accumulator.

20. The accumulator of claim 18, wherein said electronic circuit is configured for supplying a voltage signal to the signal terminal when a predefined threshold value of a first time derivative of a state variable is exceeded, wherein said state variable is selected from the group consisting of a voltage of the accumulator, a current of the accumulator, an inner resistance of the accumulator and a temperature of the accumulator.
